(19) United States
(12) Patent Application Publication
(10) Pub. No.: US 2008/0231216 A1
(43) Pub. Date: Sep. 25, 2008

(54) Method for control of a reluctance motor

(75) Inventor: Uwe Caldewey, Dortmund (DE)

Correspondence Address: COLLARD & ROE, P.C., 1077 NORTHERN BOULEVARD, ROSLYN, NY, 11576, US

(73) Assignee: Vorwerk & Co. Interholding GmbH

(21) Appl. No.: 12/077,176

(22) Filed: Mar. 17, 2008

(30) Foreign Application Priority Data
Mar. 22, 2007 (DE) 10 2007 013724.0

(51) Int. Cl. H02P 25/08

(52) U.S. Cl. 318/254.1

(57) ABSTRACT

The invention relates to a method for control of a reluctance motor which has a rotor (1) and a stator (4), the rotor (1) having a plurality of rotor segments (3) and the stator (4) having a number of coils (6), the number of coils being dependent on the number of rotor segments, thus in particular four coils (6) in the case of two rotor segments (3), and the motor having a control unit which applies a voltage to a coil (6) of a respective phase (PH1) of the stator (4) over a specific angular sector of the movement of the rotor (1) between a switch-on time (E) and a switch-off time (A). In order to provide an improved method of the kind in question by means of which control of an advantageous reluctance motor may be achieved, it is proposed that the switch-on time (E) of a phase (PH1) is selected to be delayed, so as to be different from a geometric pitch (G) of the angular sector of each coil (6), i.e. later than corresponds to the geometric pitch (G), while the switch-off time (A) is maintained in correspondence with the geometric pitch (G).

### CROSS REFERENCE TO RELATED APPLICATIONS

Applicant claims priority under 35 U.S.C. §119 of German Application No. 10 2007 013 724.0 filed Mar. 22, 2007.

The invention relates to a method for control of a reluctance motor which has a rotor and a stator, the rotor having a plurality of rotor segments and the stator having a number of coils, the number of coils being dependent on the number of rotor segments, thus in particular four coils in the case of two rotor segments, and the motor having a control unit which applies a voltage to a coil of a respective phase of the stator over a specific angular sector of the movement of the rotor between a switch-on time and a switch-off time.

Reluctance motors function basically with direct current. An intermediate circuit is necessary for operation. Significant losses occur in the case of motors of this kind, in particular in the windings of the rotor and stator, and also in the iron. A method for control of a reluctance motor of this kind is known for example from DE 102 29 443 A1. The content of this patent application is hereby included in full in the disclosure of the present application, also for the purpose of incorporating features of this patent application in claims of the present invention.

In the light of the above-described state of the art, a technical problem for the invention in the provision of a improved method of the kind in question, by means of which control of an improved reluctance motor may be achieved.

This problem is solved first and foremost by the subject matter of Claim 1, it being provided that the switch-on time of a phase is selected to be delayed, so as to be different from a geometric pitch of the angular sector of each coil, i.e. later than corresponds to the geometric pitch, while the switch-off time is maintained in correspondence with the geometric pitch. The switch-on time and switch-off time are in particular established by sensors. It is known in this regard to provide rotor position detection. On account of the high speeds of rotation usual as a rule in the case of reluctance motors, speeds of more than 400 rpm (revolutions per minute), further more than 1,000 rpm up to 30,000 rpm and more, a two-phase switched reluctance motor is used. The advantage here is the low number of switching actions per revolution, so that the power loss in the electronics can be arranged to be favourable. In the case of a two-phase motor of this kind, four steps are executed per 360 degrees of rotation. Each phase thus switches twice per revolution. There results from this a geometric pitch of 90 degrees. In order to detect position, there is used as a rule a sensor which delivers static signals. For a sector of 90 degrees, a logical zero or a logical one is alternatingly signalled. The switch-over point of the sensor system is in the region of the so-called aligned position. On account of the lack of current limits, in the case of high speed, the motor is driven by pulse width modulation. In this, the pulse width is determined such that a current limit is set. The high-speed switched reluctance motor behaves more favourably when, instead of the possible geometric 90 degree angular sector, a switching angle sector is selected which is by contrast smaller. This is achieved by displacing the switch-on time to a time which is delayed in the direction of rotation of the rotor, while the switch-off time corresponds to the geometric pitch. The same also applies to, for example, four-phase switched reluctance motors with four rotor segments and six associated coils, the geometric angular sector then equating to 60 degrees. Also in the case of such a configuration, the switch-on time of the respective phase is selected according to the invention to be delayed, this with the switch-off time being maintained.

The driving voltage is simultaneously raised. Accordingly, the high-speed switched reluctance motor is designed for drive at an over-voltage. If the nominal voltage is, for example, 230 volts, the fully energized motor (thus the motor energized over the full geometric angular sector) is designed for 190 to 210 volts. The proposed method results in a reallocation of the losses. The copper losses go down, as against which the iron losses are increased. By cooling the motor via its external surface, there results thereby a still further advantage. By the copper losses being reduced, less copper is needed from the point of view of cooling. Furthermore, by virtue of the proposed method, operation with a small intermediate circuit capacitor is possible. Even operation with an electrolytic capacitor is not necessary. Rather a conventional capacitor may be used, for example a 3 to 6 μF capacitor, further for example a 4.7 μF capacitor.

In the following text, features are described which are of significance preferably in combination with the features of Claim 1, but which may basically be also of significance with only some features of Claim 1 or on their own.

Thus it is further provided that the delay angle sector is 10% or more of the geometric pitch, thus 9 degrees or more in the case of a two-phase motor and a corresponding geometric pitch of 90 degrees. Accordingly, the switch-on time is delayed by this angle, this having further the result that the phase-wise switch-on angular sector is reduced. Energization of the switched phase is therefore only effected, for example over an angular sector which equates to 90% or less of the geometric angular sector. The switch-off time of the phase is here always maintained, only the switch-on time being delayed with a higher voltage. In a further development, it is provided that the delay angle sector is preferably 20 to 25% of the geometric pitch, thus more preferably about 18 to 22.5 degrees in the case of a two-phase motor, which corresponds to energization of the phase accordingly over 67.5 to 72 degrees. In a four-phase motor, energization would not correspond to the geometric angular sector of 60 degrees, but rather to only 45 to 48 degrees, because of the delay of the switch-on time by 12 to 15 degrees. It proves to be especially advantageous if the delay angle sector is 20 degrees in the case of a geometric angular sector of 90 degrees. Instead of the possible 90 degrees, each phase is energized for only 70 degrees. Because of this, there results a reduction in the copper losses of ca. 10 to 20%.

Finally, it is proposed that the voltage applied to a coil is higher that the design voltage of the reluctance motor when a phase is energized over the entire angular sector. The design voltage of the reluctance motor operated at a nominal voltage of for example 230 volts is, in the case of reduced energization, referred to a newly resulting effective value, thus for example to 200 to 220 volts, further for example 209 volts. By reducing the energization, there is meant in the sense of the invention, an energization effected not over the full duration, but with the current level not however being changed. The higher voltage (for example 209 volts) compared with the motor design acts on the motor for a shortened time, so that on average—in particular by the reallocation of the losses described—no increased heating results.

The invention is described in more detail below with reference to the accompanying drawing, which illustrates only one embodiment, and in which:

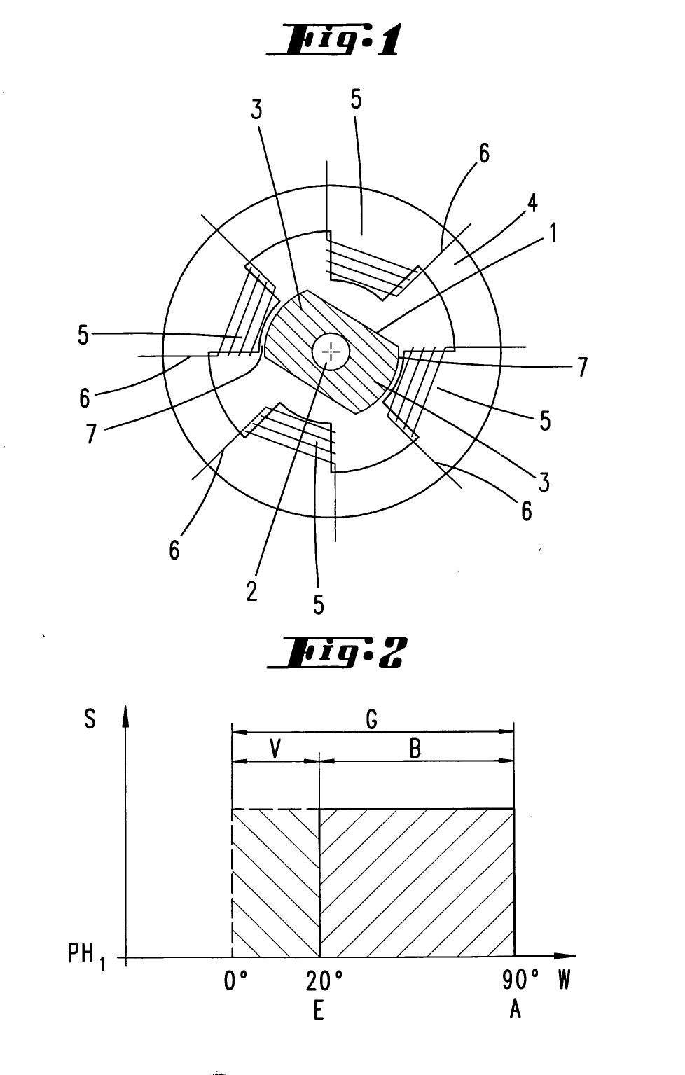

FIG. 1 shows a two-phase motor in schematic illustration;

FIG. 2 is a diagram for illustrating the current energization angle sector compared to the geometric angle sector, with reference to a phase to be energized.

A two-phase reluctance motor is illustrated schematically in FIG. 1. The rotor 1, which is seated in a fixed manner on a rotor shaft 2 so as to rotate with the shaft, has two rotor poles (rotor segments) 3, which are located diametrically opposite each other.

The stator 4, which surrounds the rotor 1, has four stator poles 5, which are in each case at an angle of 90° with respect to one another in the direction of rotation of the rotor 1. These carry in each case stator windings forming coils 6.

An annular airgap 7 remains between the rotor poles 3 and the corresponding stator poles 5 during operation.

In the case of a two-phase motor of this kind, four steps are executed for a 360 degree rotation of the rotor 1. Each phase switches therefore twice per revolution. In order to detect the position of the rotor, a sensor (rotor position detection)—not illustrated—is used, the sensor delivering signals S.

A schematic diagram is shown in FIG. 2, in which the energization of the phase PH1 in dependence on the sensor signals S is set out. In accordance with the two-phase construction of the motor, sensor signals are transmitted in each 90-degree position of the rotor 1, from which a geometric angular sector G of 90 degrees is set. Thus a first signal is delivered by the sensor at 0 degrees, and a further signal after 90 degrees in the direction of rotation of the rotor, this representing simulataneously the switch-off time A for the energization of the phase.

The switch-on time E for the energization of the phase is delayed with respect to the geometric angular sector G. Accordingly no phase energization is initially effected over a predefined delay angular sector V, thus in the case of the exemplary embodiment illustrated, over the first twenty degrees measured from the first sensor signal. As a result, energization of the phase PH1 is effected in the exemplary embodiment illustrated only over an energization angle sector B of 70 degrees.

Since the switch-off time is maintained in accordance with the geometric pitch G, no phase overlap occurs, in particular in the case of very high speeds of rotation of several thousand rpm. Rather one phase switches off in accordance with the geometric pitch at the prescribed switch-off point A, while the next phase only switches on later by the extent of the delay angle sector V.

For motors for which the speed of rotation can be controlled, the proposed method may come into action however only when a predetermined speed of rotation is exceeded, for example, if 400 rpm or more is exceeded, but by contrast in the case of lower speeds of rotation, a different method of control may however also be used, this being suitably adapted to lower speeds of rotation.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. Method for control of a reluctance motor which has a rotor (1) and a stator (4), the rotor (1) having a plurality of rotor segments (3) and the stator (4) having a number of coils (6), the number of coils being dependent on the number of rotor segments, thus in particular four coils (6) in the case of two rotor segments (3), and the motor having a control unit, which applies a voltage to a coil (6) of a respective phase (PH1) of the stator (4) over a specific angular sector of the movement of the rotor (1) between a switch-on time (E) and a switch-off time (A), wherein the switch-on time (E) of a phase (PH1) is selected to be delayed, so as to be different from a geometric pitch (G) of the angular sector of each coil (6), i.e. later than corresponds to the geometric pitch (G), while the switch-off time (A) is maintained in correspondence with the geometric pitch (G).

2. Method according to claim 1, wherein that the delay angle sector (V) is 10% or more of the geometric pitch (G).

3. Method according to claim 1, wherein the delay angle sector (V) is preferably 20 to 25% of the geometric pitch (G).

4. Method according to claim 1, wherein the delay angle sector (V) is 20 degrees in the case of a geometric pitch (G) of 90 degrees.

5. Method according to claim 1, wherein the voltage applied to a coil is higher than the design voltage of the reluctance motor when a phase is energized over the entire angular sector.
